(19) United States
(12) Patent Application Publication
(10) Pub. No.: US 2006/0266795 A1
(43) Pub. Date: Nov. 30, 2006

(54) Method for printing a surface

(76) Inventors: Roland Heckenthaler, Gabsheim (DE); Walter Holzapfel, Kassel (DE); Harald De Buhr, Kronberg (DE)

Correspondence Address: FISH & RICHARDSON PC, P.O. BOX 1022, MINNEAPOLIS, MN, 55440-1022, US

(21) Appl. No.: 10/554,302

(22) PCT Filed: Mar. 24, 2004
(86) PCT No.: PCT/EP04/03096

§ 371 Date: May 25, 2006

(30) Foreign Application Priority Data
Apr. 26, 2003 (DE) 103 18 909.2

(51) Int. Cl. A47J 36/02

(52) U.S. Cl. 228/101

(57) ABSTRACT

A method for printing a plastic surface by means of hot-stamping with a metallic hot-stamping tool that can be heated and is coated with plastic is described. The plastic-coated outer surface of the hot-stamping tool forms the stamping surface. The stamping surface transfers a pigment layer applied onto the carrier foil to the work piece when the carrier foil is pressed against the surface of a work piece to be printed. The work piece surface to be printed is preheated before the printing process with the aid of a heating device, wherein the temperature of the stamping surface of the hot-stamping tool lies between 140° C. and 240° C.,. This extends the service life of the hot-stamping tools and the set-up times of the hot-stamping device are simultaneously reduced.

### TECHNICAL FIELD

The invention pertains to a method for printing a surface, more particularly a plastic surface, by means of hot-stamping.

### BACKGROUND

Surfaces of plastic parts are frequently decorated or printed with the aid of hot-transfer and hot-stamping methods. In contrast to the hot-transfer method, a foil coated with a monotone ink over its entire surface is used in the hot-stamping method. In this case, the printed image is produced by the contour of the stamping tool (e.g., a print wheel or a dot-matrix print head). Preprinted images, writings, logos, etc., are used in the hot-transfer method. In this case, the image with all its information is already preprinted on the foil.

Hot-transfer and hot-stamping methods require different temperatures and different stamping times, depending on the respective plastic material. In all hot-stamping/transfer methods, pre-applied pigments are transferred by a foil. Heat needs to be supplied in order to realize this transfer. The heat is used for activating the “separation layer” on the foil and the hot-melt adhesive for fixing the pigments on the substrate. This heat is generally transmitted through the foil by a heated hot-stamping tool.

A hot-transfer stamping tool usually consists of an aluminum carrier with a silicone coating that is adapted to respective process and serves for compensating the surface unevenness of the plastic part to be decorated. The inferior thermal conductivity of the silicone coating on the hot-stamping tool results in a high temperature gradient between the aluminum carrier and the outer silicon surface of the hot-stamping tool. Consequently, the recovery time for the silicon surface is insufficient, particularly when operating with short cycle times as it is the case, for example, in the manufacture of toothbrushes. This means that the aluminum carrier needs to have a higher temperature in order to reach the optimal working temperature. If the standstill times of the hot-stamping tool exceed 20 sec., an excessively high stamping tool temperature of approximately 260° C.-280° C. results. The high temperature results in the manufacture of rejects until the operating temperature is reached again. Any attempts to counteract the temperature on the hot-stamping tool would be unsuccessful because the system of the hot transfer press reacts quite sluggishly.

DE 34 40 131 C2 discloses a method for printing a substrate by means of hot-stamping. This method proposes to preheat a stamping foil to a temperature that lies slightly below the melting temperature of the pigments applied to the foil. Lettering can only be applied on a very thin substrate in this case because the metallic surface of the hot-stamping tool brings the information producing pigments in contact with the heated counterpressure element and the stamping foil through the substrate. It would be inconceivable to utilize such a method for surface decorating applications.

DE 101 48 975 A1 describes a method and a device for printing objects, in which a heated stamping tool presses a pigment layer arranged on a hot-stamping foil against a work piece surface to be printed such that the image adhering to the hot-stamping foil is transferred onto the surface of the work piece. After the image is transferred and the hot-stamping foil is removed from the stamping tool, the hot-stamping foil remains on the object to be printed for a certain period of time in order to ensure that the layer printed onto the object securely adheres thereto.

In DE 43 08 977 A1, a varicolored decor is printed on a plumbing fixture by means of a hot-stamping method. The plumbing fixture is heated to a temperature of at least 100° C. in order to ensure that the image to be transferred from the hot-stamping foil adequately adheres to the plumbing fixture.

It is desirable to lower the temperature of the hot-stamping tool such that its service life can be extended and the machine down-times can be reduced. This should simultaneously make it possible to lower the number of rejects produced due to the start-up of the machine. It should also be possible to improve the adhesion of an image being transferred with the same stamping tool temperature within a shorter stamping time, as well as to achieve a more secure adhesion of the decor or printed layer, respectively.

### SUMMARY

In one aspect of the invention, a heating device is arranged above the work piece surface to be printed such that at least the entire surface to be decorated is homogenously heated. This makes it possible to lower the stamping tool temperature during the printing process because the heat required for separating and transferring the pigment layer to the work piece surface no longer has to be generated by the stamping tool alone. Therefore, the recovery time of the silicone surface on the hot-stamping tool can be shortened such that the cycle time can be increased and the costs for the manufacture of respective objects are reduced. Another advantage can be seen in that the stamping tool temperature no longer increases excessively during down-times because the stamping tool temperature is set lower to begin with. The temperature on the stamping surface lies between 140° C. and 240° C., preferably between 200° C. and 220° C. This means that the upper temperature range can be respectively lowered by 40° C. to 60° C. The reduction of the temperature on the hot-stamping tool results in the coated plastic foil being subjected to a lower thermal load and therefore less susceptible to wear. The surface temperature of the hot-stamping tool is adjusted higher or lower depending on the choice of temperature-sensitive plastic material for the work piece. The temperature on the stamping surface is then regulated accordingly. These temperatures should be adapted in such a way the stamping surface has the lowest temperatures possible and the work piece surface has the highest temperature possible, wherein the latter cannot cause any damages to the work piece surface to be printed.

It is possible to realize different absorption characteristics of the plastic surfaces to be printed during the stamping process by respectively adapting the heating power or the heating time accordingly. When stamping surfaces that require more heat for being heated to a certain temperature, it is either necessary to extend the heating time or to increase the heating power. This makes it possible to reach the same final temperature on different work piece surfaces within the same period of time such that the hot-stamping tool is not unnecessarily subjected to thermal loads. An optimal image is produced and an intensive adhesion is achieved due to the more homogenous temperatures on the stamping tool and on the work piece to be printed.

In some embodiments, the surface texture and the temperature of the work piece surface to be printed are determined by a sensor that forwards the data to an evaluation device in order to adapt the heating power or the heating time of the heating device in accordance with the evaluated data. This makes it possible to always reach the same temperatures on the work piece surfaces to be heated and printed within the same period of time. Naturally, this also makes it possible to increase the cycle times because the stamping tool no longer has to heat the surface to be printed for an extended period of time.

In some embodiments, the heating device consists of an infrared lamp. Infrared lamps allow a defined and reproducible heating of the surfaces to be printed by adjusting the time, the power, the distance from the work piece and the type of focusing accordingly. Infrared lamps of this type are also particularly inexpensive. In addition, it is very simple to decrease or increase the distance of the infrared lamp from the work piece surface in order to increase the thermal radiation on the surface to be printed. However, it would also be conceivable to utilize other heating devices such as, for example, fan heaters, laser lights, gas flames or other suitable heat sources for heating a work piece.

It can be advantageous that the surface to be printed is heated to a temperature between 30° C. and 250° C., wherein plastic surfaces are preferably heated to a temperature between 80° C. and 120° C. Depending on the surface to be printed and the work piece material, the surface temperatures on the work piece and on the stamping tool are adjusted in such a way that the lowest thermal load possible occurs on the hot-stamping tool. Excessively high temperatures on the work piece surface to be printed could lead to damages thereof. In some embodiments, the surface to be printed consists of a plastic toothbrush.

However, this method also makes it possible to print surfaces of different objects, e.g., housings of safety razors, household appliances, etc. The method can be carried out in a particularly advantageous fashion on polypropylene materials. In this respect, it is also possible to utilize any plastic material that can be printed by means of a corresponding printing foil.

An in-line measurement, i.e., the actual temperature of the surface to be printed can be continuously monitored while it is heated until the desired temperature is reached, is also possible. It can be advantageous to coat the hot-stamping tool with a silicone layer. This elastic coating makes it possible to compensate the unevenness of the surface to be printed, i.e., the silicone layer flatly adjoins the printing foil and uniformly presses the printing foil against the work piece surface to be printed. Consequently, the pigment layer is also applied onto a work piece surface that is uneven to a certain degree with a uniform pressure such that a consistent adhesion is achieved at all locations.

In some embodiments, the silicone layer has a thickness between 1 and 4 mm, preferably between 2 and 3 mm. These thicknesses make it possible for the silicone layer, i.e., the hot-stamping tool, to uniformly press the pigment layer against the work piece surface to be printed. Naturally, the surface of the hot-stamping tool needs to be largely adapted to the work piece surface to be printed in order to achieve a uniform contact pressure.

### DESCRIPTION OF DRAWINGS

FIG. 1 is a block diagram of a hot-stamping device.

### DETAILED DESCRIPTION

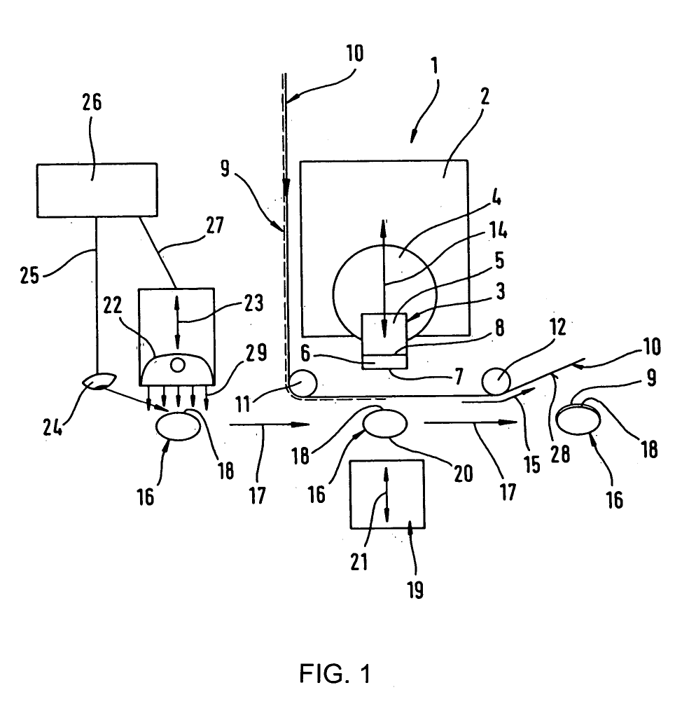

Referring to FIG. 1, the hot-stamping device 1 is illustrated in the form of a block diagram in the only figure in order to better illustrate its basic design. The hot-stamping device 1 consists of a hot-stamping tool 3 that is fixed on a raising and lowering device 2 and comprises an aluminum base 5 that is in thermal contact with a heating block 4. On its surface 8 that points downward in the figure, this aluminum base is provided with a thick silicone coating 6 that elastically yields under pressure and the exposed bottom surface of which forms the stamping surface 7.

According to the FIG. 1, a carrier foil 10 with a pigment layer 9 (illustrated with broken lines) arranged thereon is conveyed underneath the stamping surface 7 and tensioned by means of guide rollers 11, 12 and a not-shown tensioning device. In the embodiment shown, the guide roller 11 is arranged to the left and the guide roller 12 is arranged to the right of the hot-stamping tool 3, wherein both guide rollers are arranged at the same height such that the carrier foil 10 is conveyed horizontally within this region. The moving direction 14 of the raising and lowering device extends perpendicular to the carrier foil 10 such that essentially no transverse forces can act thereupon and possibly cause the carrier foil to be shifted laterally or even to be conveyed in an accelerated fashion in the transport direction 15.

Relative to the transport direction 17, the carrier foil 10 extends vertically upward upstream of the guide roller 11 and is wound on a not-shown reel at this location. The carrier foil 10 is also wound on a not-shown reel to the right of the guide roller 12, wherein the pigment layer 9 no longer adheres to the carrier foil on this side because it was already printed onto the surface 18 of a work piece 16 during the printing process. In the region that lies underneath the carrier foil 10 and between the guide rollers 11, 12, work pieces 16 to be printed are equidistantly arranged on a conveyor belt that is not illustrated in the figure and transported parallel to the carrier foil 10 from the left to the right as indicated with arrows 17.

The work pieces 16 are preferably manufactured of plastic and comprise the surface 18 to be printed, wherein the pigment layer 9 is already printed onto the work piece 16 illustrated to the right of the hot-stamping tool 3. The surfaces 18 of the work pieces 16 are curved in the embodiment shown. However, this is inconsequential during the printing process because the hot-stamping tool 3 is provided with a relatively thick silicon coating 6 that flatly adjoins the surface 18 of the work piece 16 during the printing process due to its elastic deformation. This means that the silicone coating presses the carrier foil 10 very uniformly against the surface 18 of the work piece 16, and that the pigment layer 9 is pressed against the entire surface 18 to be printed in an equally uniform fashion.

A counterpressure device 19 is arranged underneath the centrally positioned work piece 16 in the figure. When the hot-stamping tool 3 moves downward toward the work piece 16, the counterpressure device is simultaneously displaced upward until it contacts the underside 20 of the work piece 16 and enables the hot-stamping tool 3 to exert its full stamping pressure upon the surface 18 of the work piece 16, namely such that the work piece 16 is prevented from shifting upward or downward during this process. This means that the moving direction 21 of the counterpressure device 19 extends upward in the figure before the printing process and downward after the printing process. The lifting device 21 and the raising and lowering device 2 form an actuating unit and lie on a common axis, wherein said devices always operate in opposite directions. Only these measures ensure that the work piece 16 is aligned with the hot-stamping tool 3 and the counterpressure device 19 in order to centrally apply the compressive forces to the work piece.

FIG. 1 shows that a heating device 22 in the form of an infrared lamp is arranged above the surface 18 of the work piece 16 to the left of the stamping tool 3, wherein said infrared lamp can preferably also be adjusted upward and downward as indicated with the arrows 23. A sensor 24 arranged laterally adjacent to the heating device 22 serves for determining the type of work piece 16 and the texture of the surface 18 of the work piece 16, as well as for subsequently transmitting corresponding electric signals to an electronic evaluation device 26 via the line 25. The electronic evaluation device 26 then calculates the corresponding quantity of heat with the aid of a (not shown) microprocessor and controls the heating device 22 via the line 27 in such a way that its upward or downward movement is extended or shortened or its thermal radiation is increased. Naturally, it would also be conceivable to increase or decrease the speed and therefore the cycle time of the (not shown) conveyor belt in order to heat the surface 18 of the work piece 16 to the required temperature. Such an embodiment is particularly advantageous if different work pieces are situated on the conveyor belt and need to be alternately printed in random succession. The thermal radiation emitted by the heating device 22 is indicated with the reference symbol 29.

The sensor 24 may consist of a pyrometer that allows an inline measurement, i.e., the temperature on the surface 18 of the work piece 16 to be printed is determined simultaneously with the thermal radiation emitted by the heating device 22. Such an in-line measurement can be carried out with a pyrometer. The pyrometer needs to operate in a wavelength range that lies outside the wavelength range of the infrared lamp such that the temperature is measured directly on the surface 18. The surface 18 is heated until a predetermined temperature is reached. Although the surfaces 18 to be printed may have different colors, measuring errors caused by color differences can be neglected because all these surfaces consist of the same material. The determination of the color can be eliminated in this case. These measurements would make it possible to document the ongoing production and to automatically counteract a reduction in the lamp power (lamp aging).

The hot-stamping device 1 operates as described below.

The hot-stamping tool 3 is initially heated to its predetermined temperature with the aid of the heating block 4. As soon as the required temperature is reached (or even earlier), the heating device 22 is switched on and the first work piece 16 is heated to the required temperature on its surface 18. As briefly described above, this is achieved with the aid of the sensor 24 and the evaluation device 26. As soon as the temperature is reached, the conveyor belt is set in motion and the work pieces are transported in the direction 17 until a work piece is situated vertically underneath the stamping surface 7. The carrier foil 10 is situated between the stamping surface 7 and the work piece surface 18, wherein the pigment layer 9 of the carrier foil is arranged on the underside 28 that faces the surface 18 of the work piece 16. The hot-stamping tool 3 as well as the counterpressure device 19 are now moved toward the work piece 16 such that the pigment layer 9 is homogenously pressed against the surface 18 of the work piece 16 by the elastic stamping surface 7. Since the surface 18 of the work piece 16 is still sufficiently hot and the stamping surface 7 is heated to its working temperature, the pigment layer 9 is separated from the carrier foil 10 and adheres to the surface 18 of the work piece 16. In this case, certain adhesives in the pigment layer 9 contribute to producing a rigid connection between the pigment layer 9 and the surface 18 of the work piece 16. Naturally, particles of the pigment layer 9 are also fused into the surface 18 of the work piece 16 in order to produce an intimate connection between the pigment layer 9 and the surface 18.

While a work piece 16 is transported underneath the hot-stamping tool 3, a new work piece 16 is simultaneously conveyed underneath the heating device 22 and heated on its surface 18 by the heating device 22 in the instant in which the printing process takes place. The hot-stamping tool 3 and the counterpressure device 19 are now moved apart from one another and the conveyor belt conveys the printed work piece 16 toward the right in the conveying direction 15 such that it can be subsequently removed from the conveyor belt after a short cooling time.

The printed work piece 16 is now provided with the pigment layer 9 on its surface 18. The carrier foil 10 is then once again incrementally moved toward the right in the figure in order to position a section of the carrier foil 10 containing a pigment layer 9 within the stamping region. The carrier foil 10 with the pigment layer 9 separated therefrom is wound up on a not-shown reel on the right side in the figure. After the corresponding heating process, the next work piece 16 is transported underneath the hot-stamping tool 3 and printed. This process is continued in a cyclic fashion, wherein the quantity of work pieces 16 that can be printed within a very short time is significantly increased in comparison with conventional arrangements, namely because the surface 18 is heated to the required temperature by the heating device 22, and not by the stamping tool 3, before the hot-stamping tool 3 presses the pigment layer 9 on the surface 18 of the work piece 16. This means that an exchange of a hot-stamping tool 3 due to a thermal overload is no longer required.

1. A plastic surface printing method comprising:
providing a metallic hot-stamping tool with a plastic-coated outer stamping surface
using a heating device, preheating a work piece surface to be printed; and
using the stamping surface to press a carrier foil against a surface of the work piece such that a pigment layer is transferred from the carrier foil onto the work piece
wherein the work piece surface to be printed is preheated to a temperature of between 140° C. and 240° C.

2. The method according to claim 1, wherein preheating the work piece surface comprises adapting a heating power of the heating device in response to a texture of the surface to be printed.

3. The method according to claim 2, wherein adapting the heating power comprises:
sensing the texture of the surface to be printed by means of a sensor; and
forwarding data indicative of the sensed texture to an evaluation device that subsequently adjusts the heating power of the heating device.

4. The method according to claim 1, wherein preheating the work piece surface comprises locally heating the work piece surface to be printed, by means of an infrared lamp or a fan heater.

5. The method according to claim 1, wherein the work piece surface is heated to a temperature between 3° C. and 25° C.

6. The method according to claim 1, wherein the work piece surface is heated to a temperature between 80° C. and 120° C.

7. The method according to claim 1, wherein the preheated work piece surface comprises a surface of a plastic toothbrush.

8. The method according to claim 7, wherein the toothbrush surface consists of a thermoplastic plastic.

9. The method according to claim 3, wherein the texture is sensed by a pyrometer.

10. The method according to claim 1, wherein the hot-stamping tool is coated with a silicon layer.

11. The method according to claim 10, wherein the silicone layer has a thickness between 1 and 4 mm.

12. The method according to claim 11, wherein the silicone layer has a thickness between 2 and 3 mm.

13. The method according to claim 1, wherein the stamping surface is preheated to a temperature between 200° C. and 220° C.

14. A plastic surface printing method, the method comprising:
providing a metallic hot-stamping tool with a plastic-coated outer surface that forms a stamping surface;
preheating a work piece surface to be printed;
heating the stamping surface to a temperature between 140° C. and 240° C.; and
using the heated stamping surface to press a carrier foil against a surface of the preheated work piece such that a pigment layer is transferred from the carrier foil onto the work piece.

15. The method according to claim 14, wherein preheating the work piece surface comprises adapting a heating power of a work piece surface heater in response to a sensed texture of the work piece surface.

16. The method according to claim 15, wherein adapting the heating power comprises:
sensing the texture of the surface by means of a pyrometer;
forwarding sensor data from the pyrometer to an evaluation device; and
by the evaluation device, subsequently adjusting the heating power of the heater.

17. The method according to claim 14, wherein preheating the work piece surface comprises locally heating the work piece surface using an infrared lamp.

18. The method according to claim 14, wherein the work piece surface is preheated to a temperature between 80° C. and 120° C.

19. The method according to claim 14, wherein the hot-stamping tool is coated with a silicon layer that has a thickness between 2 and 3 mm.

20. The method according to claim 14, comprising heating the stamping surface to a temperature between 200° C. and 220° C.
